(19) United States
(12) Patent Application Publication
(10) Pub. No.: US 2023/0289417 A1
(43) Pub. Date: Sep. 14, 2023

(54) METHOD FOR PROCESSING FINGERPRINT INFORMATION, HARDWARE ACCELERATOR AND FINGERPRINT VERIFICATION DEVICE

(71) Applicant: Egis Technology Inc., Hsinchu City (TW)

(72) Inventors: Keng-Hsien Lin, Hsinchu City (TW); Da Lung Zou, Hsinchu City (TW); Chia-Wei Lin, Hsinchu City (TW)

(21) Appl. No.: 17/982,811

(22) Filed: Nov. 8, 2022

Related U.S. Application Data
(60) Provisional application No. 63/317,549, filed on Mar. 8, 2022.
(60) Provisional application No. 63/339,983, filed on May 10, 2022.

(30) Foreign Application Priority Data
Sep. 5, 2022 (CN) 202211081276.8

(51) Int. Cl. G06F 21/32; G06F 9/50

(52) U.S. Cl. CPC G06F 21/32; G06F 9/5027

(57) ABSTRACT

A method for processing fingerprint information includes acquiring, in response to detection of a software-initiated fingerprint verification request, verification data from the fingerprint verification request by a hardware accelerator, performing fingerprint verification on the verification data by the hardware accelerator to obtain a processing result, and outputting, by the hardware accelerator, the processing result into a memory address specified by the software. According to the solution, instead of the traditional fingerprint verification mode which completely depends on software, a hardware accelerator is used to perform verification on the verification data and output a processing result, thereby improving the bottleneck of fingerprint verification speed.

### CROSS-REFERENCE TO RELATED APPLICATION AND CLAIM OF PRIORITY

This application claims the benefit under 35 USC § 119 of U.S. Patent Application No. 63/317,549 filed on Mar. 8, 2022, U.S. Patent Application No. 63/339,983 filed on May 10, 2022 and Chinese Patent Application No. 202211081276.8, filed on Sep. 5, 2022, in the China Intellectual Property Office, the entire disclosure of which is incorporated herein by reference for all purposes.

### BACKGROUND

### 1. Technical Field

The present disclosure generally relates to the field of information processing technologies. More specifically, the present disclosure relates to a method for processing fingerprint information, and a hardware accelerator and a fingerprint verification device for performing the method.

### 2. Background Art

This section is intended to provide a background or context for the embodiments of the present disclosure that are recited in the claims. The description herein may include concepts that can be pursued, but are not necessarily ones that have been previously conceived or pursued. Therefore, unless otherwise indicated herein, what is described in this section is not prior art to the description and claims of the present application and is not admitted to be prior art by inclusion in this section.

With the development of biometric technologies, fingerprint verification technology, as one of the biometric technologies, has been applied to many fields such as people's production and life. In the related art, software is usually used in fingerprint verification to verify whether the input fingerprint is matched with data in a fingerprint database. However, as the fingerprint database increases, this method of fingerprint verification performed by software becomes a bottleneck of fingerprint verification speed, and thereby influences the use experience.

### SUMMARY

To solve at least the technical problem described in the background section above, the present disclosure proposes a solution for processing fingerprint information. With the solution of the present disclosure, the fingerprint verification efficiency can be effectively improved. In view of this, the present disclosure provides solutions in a number of aspects as follows.

In a first aspect, the present disclosure provides a method for processing fingerprint information, comprising: acquiring, in response to detection of a software-initiated fingerprint verification request, verification data from the fingerprint verification request by a hardware accelerator; performing fingerprint verification on the verification data by the hardware accelerator to obtain a processing result; and outputting, by the hardware accelerator, the processing result into a memory address specified by the software.

In an embodiment, the verification data includes at least fingerprint-to-be-verified information and reference fingerprint information, and performing fingerprint verification on the verification data by the hardware accelerator to obtain the processing result comprises: verifying, in response to obtaining the fingerprint-to-be-verified information and the reference fingerprint information transmitted from the software, whether the fingerprint-to-be-verified information conforms to the reference fingerprint information, so as to obtain the processing result.

In an embodiment, verifying whether the fingerprint-to-be-verified information conforms to the reference fingerprint information so as to obtain the processing result comprises: computing, with a Popcount algorithm, a total count of bits with different values in corresponding bits of the fingerprint-to-be-verified information and the reference fingerprint information, and taking the total count as the processing result.

In an embodiment, the verification data further includes storage parameters, and outputting the processing result into the memory address specified by the software comprises: determining, in response to obtaining the storage parameters transmitted from the software, a storage mode of the processing result according to the storage parameters; and outputting the processing result into the memory address according to the storage mode.

In an embodiment, the storage parameters include a length value of the fingerprint-to-be-verified information, an ordering flag that identifies an ordering mode of the processing result in the memory address, and a count flag that identifies a count of reference fingerprint information.

In an embodiment, computing, with the Popcount algorithm, the total count of bits with different values in corresponding bits of the fingerprint-to-be-verified information and the reference fingerprint information comprises: computing, in response to obtaining the reference fingerprint information determined from the count flag transmitted from the software, a total count of bits with different values in corresponding bits of the fingerprint-to-be-verified information and each piece of the reference fingerprint information, to acquire a processing result for each piece of the reference fingerprint information.

In an embodiment, the method further comprises: storing, while acquiring a processing result for a current piece of the reference fingerprint information, a processing result for a previous piece of the reference fingerprint information into the memory address, so that the software simultaneously calls the processing result for the previous piece of the reference fingerprint information.

In an embodiment, the verification data further includes a trigger instruction for triggering operation of the hardware accelerator, and the method further comprises: performing, in response to acquiring the trigger instruction transmitted from the software, relevant operations responsive to the fingerprint verification request by the hardware accelerator.

In an embodiment, the method further comprises: feeding back an operating state of the hardware accelerator to the software by the hardware accelerator.

In a second aspect, the present disclosure provides a hardware accelerator, comprising: a software and hardware interaction unit configured to acquire, in response to detection of a software-initiated fingerprint verification request, verification data from the fingerprint verification request; and a processing unit configured to perform fingerprint verification on the verification data to obtain a processing result, and output the processing result into a memory address specified by the software.

In an embodiment, the verification data includes at least fingerprint-to-be-verified information and reference fingerprint information, and the software and hardware interaction unit comprises a first storage unit configured to obtain the fingerprint-to-be-verified information and the reference fingerprint information transmitted from the software; and the processing unit interacts with the first storage unit, and is specifically configured to obtain the fingerprint-to-be-verified information and the reference fingerprint information transmitted from the software, and verify whether the fingerprint-to-be-verified information conforms to the reference fingerprint information, so as to obtain the processing result.

In an embodiment, the processing unit is further configured to: compute, with a Popcount algorithm, a total count of bits with different values in corresponding bits of the fingerprint-to-be-verified information and the reference fingerprint information, and take the total count as the processing result.

In an embodiment, the verification data further includes storage parameters, the software and hardware interaction unit comprises a second storage unit, and the processing unit is configured to determine, in response to obtaining the storage parameters transmitted from the software, a storage mode of the processing result according to the storage parameters, and the second storage unit interacts with the processing unit, and outputs the processing result into the memory address according to the storage mode.

In an embodiment, the storage parameters include a length value of the fingerprint-to-be-verified information, an ordering flag that identifies an ordering mode of the processing result in the memory address, and a count flag that identifies a count of reference fingerprint information.

In an embodiment, the software and hardware interaction unit further comprises a programmable parameter unit configured to interact with the software to receive the length value of the fingerprint-to-be-verified information, the ordering flag and/or the count flag transmitted from the software; and the processing unit interacts with the programmable parameter unit, and is further configured to compute, in response to obtaining the reference fingerprint information determined from the count flag transmitted from the software, a total count of bits with different values in corresponding bits of the fingerprint-to-be-verified information and each piece of the reference fingerprint information, to acquire a processing result for each piece of the reference fingerprint information.

In an embodiment, the second storage unit is further configured to: store, while acquiring a processing result for a current piece of the reference fingerprint information, a processing result for a previous piece of the reference fingerprint information into the memory address, so that the software simultaneously calls the processing result for the previous piece of the reference fingerprint information.

In an embodiment, the verification data further includes a trigger instruction for triggering operation of the hardware accelerator, and the software and hardware interaction unit further comprises a control unit configured to interact with the software to receive the trigger instruction transmitted from the software; and the processing unit interacts with the control unit, and is further configured to perform, in response to receiving the trigger instruction transmitted from the software, relevant operations responsive to the fingerprint verification request.

In an embodiment, the control unit is further configured to: feedback an operating state of the hardware accelerator to the software.

In a third aspect, the present disclosure provides a fingerprint verification device, comprising at least a hardware accelerator as described in the first aspect of the present disclosure and in a plurality of embodiments below, and the fingerprint verification device is provided independent of a portable device, and configured to implement fingerprint verification based on interaction between the hardware accelerator and software, so as to feed back a fingerprint verification result to the portable device.

In an embodiment, the device further comprises: a sensor configured to capture fingerprint information and configured to interact with the hardware accelerator to complete fingerprint verification inside the fingerprint verification device.

In an embodiment, the fingerprint verification device is further configured to interact with an external sensor configured to capture fingerprint information, so as to interact with the external sensor to implement fingerprint verification.

With the solution of the present disclosure, instead of the traditional fingerprint verification mode which completely depends on software, a hardware accelerator may be used in fingerprint verification to perform verification on the verification data and output a processing result, thereby improving the bottleneck of fingerprint verification speed.

In addition, the present disclosure further provides a fingerprint verification device, which may interact with a portable device (for example, a device involving fingerprint technology, such as a mobile phone, a computer, or a smart watch), complete fingerprint verification with the fingerprint verification device, and provide a fingerprint verification result to the portable device as needed. Therefore, a brand-new fingerprint verification method is provided, while the portable device is prevented from accessing some sensitive data during fingerprint verification, thereby improving safety of the fingerprint verification. Specifically, in some embodiments, in addition to the hardware accelerator, the fingerprint verification device may further comprise a sensor configured to capture fingerprint information. Thereby, fingerprint verification can be completed inside the fingerprint verification device. In some other embodiments, the sensor configured to capture fingerprint information is independently provided, and the fingerprint verification device may interact with this external sensor to implement fingerprint verification.

### BRIEF DESCRIPTION OF THE DRAWINGS

Above and other objectives, features and advantages of the exemplary embodiments of the present disclosure will become readily apparent from the following detailed description with reference to the accompanying drawings. In the accompanying drawings, several embodiments of the present disclosure are illustrated by way of example but not limitation, and the same or corresponding reference numerals indicate the same or corresponding parts. In the accompanying drawings,

FIG. 1 is a flowchart of a method for processing fingerprint information according to an embodiment of the present disclosure;

FIG. 2 is a flowchart of a method for processing fingerprint information according to another embodiment of the present disclosure;

FIG. 3 is a block diagram of a hardware accelerator according to an embodiment of the present disclosure;

FIG. 4 is a block diagram of a hardware accelerator according to another embodiment of the present disclosure;

FIG. 5 is a schematic diagram showing a comparison process between fingerprint-to-be-verified information and reference fingerprint information according to an embodiment of the present disclosure:

FIG. 6 is a schematic diagram showing processing timing of software and a hardware accelerator according to an embodiment of the present disclosure;

FIG. 7 is a block diagram of a fingerprint verification device according to an embodiment of the present disclosure;

FIG. 8 is a schematic diagram showing interaction between the fingerprint verification device according to an embodiment of the present disclosure with a portable device; and

FIG. 9 is a schematic diagram showing interaction between the fingerprint verification device according to an embodiment of the present disclosure and different external devices.

### DETAILED DESCRIPTION

The technical solutions in the embodiments of the present disclosure will be clearly and completely described below with reference to the accompanying drawings in the embodiments of the present disclosure. Obviously, the described embodiments are only some of, but not all, the embodiments of the present disclosure. All other embodiments, which can be derived by those skilled in the art from the embodiments of the present disclosure without making any creative effort, shall fall within the protection scope of the present disclosure.

It should be understood that the terms “first,” “second,” “third,” “fourth,” and the like in the claims, description, and drawings of the present disclosure are used to distinguish between different objects, and are not used to describe a particular order. The terms “comprise” and “include,” when used in the description and claims of the present disclosure, specify the presence of stated features, integers, steps, operations, elements, and/or components, but do not preclude the presence or addition of one or more other features, integers, steps, operations, elements, components, and/or combinations thereof.

It is also to be understood that the terminology used in the description of the disclosure herein is for the purpose of describing particular embodiments only, and is not intended to limit the disclosure. As used in the description and claims of the disclosure, the singular forms “a”, “an” and “the” are intended to include the plural forms as well, unless the context clearly indicates otherwise. It should be further understood that the term “and/or” as used in the description and claims of the disclosure refers to any and all possible combinations of one or more of the associated listed items and includes such combinations.

The inventors have found that in the related art, software is generally used to perform the whole fingerprint verification process. As the fingerprint database increases, the fingerprint verification performed by software leads to an increasingly slower fingerprint verification speed, and becomes a bottleneck of fingerprint verification speed. In order to improve the bottleneck of fingerprint verification speed, methods such as reducing an algorithm complexity in the software or increasing an operation clock rate of the processor are generally adopted. Although these methods improve the fingerprint verification speed to a certain extent, there are also great disadvantages. For example, while the algorithm complexity is reduced, the verification precision is reduced, and when the operation clock rate of the processor is increased, the overall power consumption is greatly increased. It can be seen that the existing solution does not have an ideal effect on improving the fingerprint verification speed. In view of this, the inventors have found in research that a hardware accelerator may be used to perform some operations related to fingerprint verification, and by combining software and hardware, the dependence on software is reduced, and the bottleneck of fingerprint verification speed is effectively improved.

Specific embodiments of the present disclosure will be described in detail below with reference to the accompanying drawings.

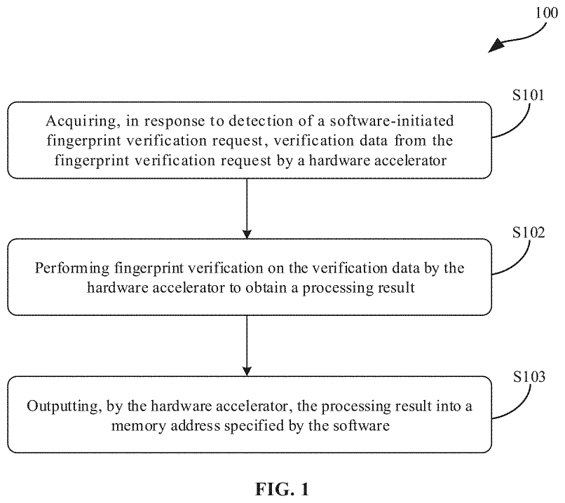

FIG. 1 is a flowchart of a method 100 for processing fingerprint information according to an embodiment of the present disclosure.

As shown in FIG. 1, at step S101, in response to detection of a software-initiated fingerprint verification request, verification data may be acquired from the fingerprint verification request by a hardware accelerator. As previously described, it is contemplated that some operations of fingerprint verification are performed by a hardware accelerator in place of software. Specifically, upon a fingerprint verification requirement, the software side may prepare verification data and initiate a fingerprint verification request containing the verification data. Then, upon detection of the fingerprint verification request, the hardware accelerator may extract the verification data from the fingerprint verification request for subsequent processing. The software side may prepare the verification data in various manners, for example, by collecting verification data in real time, by calling verification data recorded in advance, or by a combination thereof. It should be noted that the detailed description of the verification data herein is merely exemplary.

Next, at step S102, fingerprint verification may be performed on the verification data by the hardware accelerator to obtain a processing result. It has been found after a great deal of research that if a fingerprint to be verified and a fingerprint in a fingerprint database are verified by software, the overall speed of fingerprint verification will be reduced. Therefore, by verifying the verification data (such as a fingerprint to be verified, a fingerprint in a fingerprint database, or the like) with a hardware accelerator in place of software, the processing speed of the verification data is increased by virtue of the performance advantage of the hardware accelerator in fast processing of information, thereby helping to improve the bottleneck of fingerprint verification speed.

Finally, at step S103, the processing result may be output by the hardware accelerator into a memory address specified by the software, so that the software can call the processing result.

Therefore, with the smart conception of combining software and hardware, the hardware accelerator timely takes over the software to specifically perform verification on the verification data and output the processing result. This fingerprint verification method, which is different from the traditional method that completely depends on software, can effectively improve the fingerprint verification efficiency, and improve the bottleneck of fingerprint verification speed.

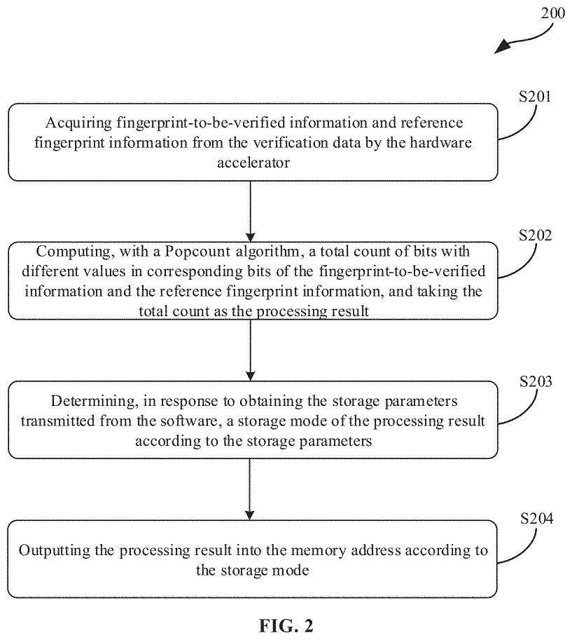

FIG. 2 is a flowchart of a method 200 for processing fingerprint information according to another embodiment of the present disclosure. It will be appreciated that the method 200 is a further limitation and extension of the method 100 in FIG. 1. Therefore, the details described above in conjunction with FIG. 1 are also applicable below.

As shown in FIG. 2, at step S201, fingerprint-to-be-verified information and reference fingerprint information may be acquired from the verification data by the hardware accelerator. The verification data may include the fingerprint-to-be-verified information and the reference fingerprint information. In some embodiments, a software side may prepare the fingerprint-to-be-verified information and the reference fingerprint information by collecting in real time, by directly calling pre-stored fingerprint information, by collecting fingerprint-to-be-verified information in real time and calling pre-stored reference fingerprint information, or the like. Then, the hardware accelerator may acquire the fingerprint-to-be-verified information and the reference fingerprint information from the verification data transmitted from the software.

Next, at step S202, a population count algorithm or a Hamming weight algorithm (referred to as Popcount algorithm for short) can be used to compute a total count of bits with different values in corresponding bits of the fingerprint-to-be-verified information and the reference fingerprint information, and the total count can be taken as the processing result. The Popcount algorithm mainly involves computing a total count of bits with different values in corresponding bits of two pieces of binary data. For example, the two pieces of data are 10 and 7, where the binary of 10 is 1010 and the binary of 7 is 0111. Then, the bits with different values in corresponding bits of 10 and 7 are bit3/bit2/bit0, so popcount=3 (abbreviated as pcnt=3, representing a processing result of 3).

In practical applications, the reference fingerprint information may include multiple pieces of fingerprint information. In this case, it is desired to use the Popcount algorithm to compute a total count of bits with different values in corresponding bits of the fingerprint-to-be-verified information and each piece of the reference fingerprint information. The reference fingerprint information may be understood as fingerprint information that can be used as a verification standard for the fingerprint-to-be-verified information. In some embodiments, the reference fingerprint information may further specifically represent a set of all information obtained each time the fingerprint sensor is pressed for enrollment. Then, a count of reference fingerprint information pieces=a count of successful presses for enrollment. In some other embodiments, the reference fingerprint information may specifically represent information of a plurality of feature points of each fingerprint that successful presses the fingerprint sensor and is placed in the reference fingerprint database. Then, the count of reference fingerprint information pieces>the count of successful presses for enrollment. It will be appreciated that how to acquire the reference fingerprint information is not limited in the present disclosure, and settings and adjustments may be specifically made based on the application requirements.

In some implementation scenarios, the verification data may further include storage parameters, which may include a length value of the fingerprint-to-be-verified information (which may be 32 bits, 64 bits or more, and the specific physical meaning thereof may be determined by a corresponding algorithm; for example, which may represent a length value of a fingerprint feature point), an ordering flag that identifies an ordering mode (for example, in close proximity, at intervals, or the like) of processing results in the memory address, and a count flag that identifies a count of reference fingerprint information (which may be specifically prepared by the software in advance based on computation performance of the hardware accelerator, for example, based on a count of reference fingerprint information that the hardware accelerator can compute at one time). In this application scenario, the hardware accelerator may compute, in response to obtaining the reference fingerprint information determined from the count flag transmitted from the software, a total count of bits with different values in corresponding bits of the fingerprint-to-be-verified information and each piece of the reference fingerprint information, to acquire a processing result for each piece of the reference fingerprint information.

After the processing of the fingerprint-to-be-verified information and each piece of the reference fingerprint information is completed, next, at step S203, in response to obtaining the storage parameters transmitted from the software, a storage mode of the processing result is determined according to the storage parameters. For example, the storage mode of the processing result may be determined according to storage locations, intervals, and the like of various fingerprint information indicated in the storage parameters.

Finally, at step S204, all the aforementioned processing results may be output into the memory address according to the storage mode. Therefore, by combining software and hardware, the dependence on software is reduced, and the bottleneck of fingerprint verification speed is effectively improved.

Further, in some embodiments, while acquiring a processing result for a current piece of the reference fingerprint information, a processing result for a previous piece of the reference fingerprint information may be stored into the memory address, so that the software simultaneously calls the processing result for the previous piece of the reference fingerprint information. By reasonably scheduling the hardware accelerator that performs fingerprint verification and the software that synchronously uses a previous processing result, the cooperation between software and hardware is further optimized, and the whole fingerprint information processing efficiency is improved.

Further, in some embodiments, the verification data may further include a trigger instruction for triggering operation of the hardware accelerator. In response to acquiring the trigger instruction transmitted from the software, relevant operations (including acquiring the verification data, performing fingerprint verification on the verification data, outputting the processing result, and the like) responsive to the fingerprint verification request are performed by the hardware accelerator, so that the hardware accelerator can be started according to actual needs, which is favorable to saving power consumption.

In some other embodiments, the hardware accelerator may be further configured to feed back an operating state of the hardware accelerator to the software. For example, the hardware accelerator may feedback a state of the hardware accelerator in each operating phase to the software, or feedback an operating state of the hardware accelerator to the software after the processing result is output (for example, after the computation is complemented, or the like). Therefore, the software may conveniently perform overall deployment based on the operating state of the hardware accelerator.

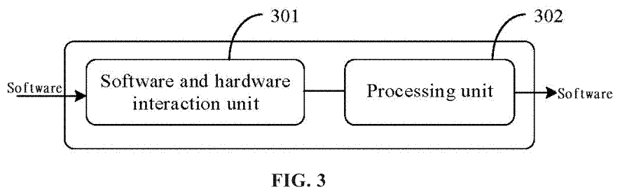

FIG. 3 is a block diagram of a hardware accelerator 300 according to an embodiment of the present disclosure. It will be appreciated that the hardware accelerator 300 is a structured apparatus corresponding to the method 100 in FIG. 1 and the method 200 in FIG. 2. Therefore, the details described above in conjunction with FIGS. 1 and 2 are merely exemplary description. In addition, in order to explain the disclosed solution more clearly, the interaction with software is also shown in FIG. 3.

As shown in FIG. 3, the hardware accelerator 300 may comprise a software and hardware interaction unit 301 and a processing unit 302. The hardware accelerator 300 may be specifically configured to acquire, in response to detection of a software-initiated fingerprint verification request, verification data from the fingerprint verification request. As previously described, the verification data may be prepared in advance by software, and a fingerprint verification request containing the verification data may be initiated timely. The software and hardware interaction unit 301 may extract the verification data from the fingerprint verification request. The processing unit 302 may be configured to perform fingerprint verification on the verification data to obtain a processing result, and output the processing result into a memory address specified by the software. With the smart conception of combining software and hardware, the hardware accelerator timely takes over the software to specifically perform verification on the verification data and output the processing result, so that the processing speed of the verification data is increased by virtue of the performance advantage of the hardware accelerator in fast processing of information, thereby helping to improve the bottleneck of fingerprint verification speed.

It should be noted that the modular division of functions inside the hardware accelerator is merely an exemplary illustration, and may be specifically adjusted according to the design requirements. For example, the software and hardware interaction unit may be implemented in a plurality of specific units.

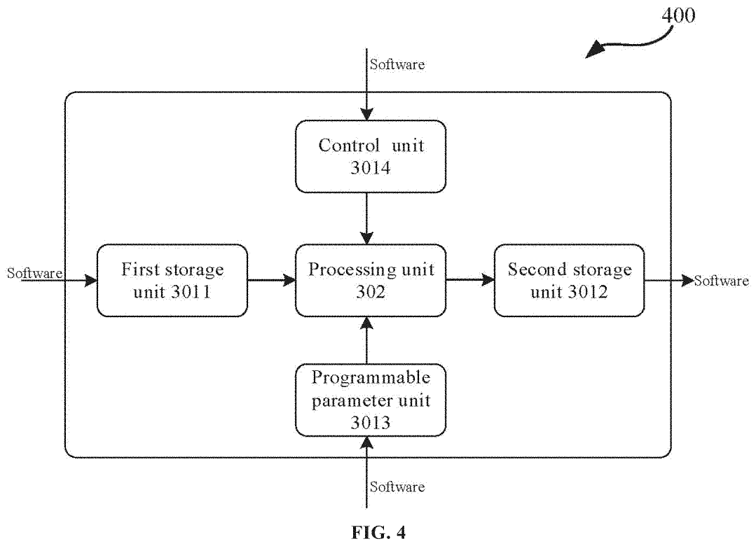

FIG. 4 is a block diagram of a hardware accelerator 400 according to another embodiment of the present disclosure. It will be appreciated that the hardware accelerator 400 is a further limitation and extension of the hardware accelerator 300 in FIG. 3, and is a structured apparatus corresponding to the methods 100 and 200. Therefore, the details described above in conjunction with FIGS. 1 to 3 are also applicable below.

Specifically, the hardware accelerator 400 may comprise a software and hardware interaction unit and a processing unit. The software and hardware interaction unit is implemented in a plurality of specific units. As shown in FIG. 4, the hardware accelerator 400 may specifically comprise a first storage unit 3011, a second storage unit 3012, a programmable parameter unit 3013, a software and hardware interaction unit 301 such as a control unit 3014, and a processing unit 302.

The processing unit 302 may interact with the first storage unit 3011, and may be specifically configured to obtain fingerprint-to-be-verified information and reference fingerprint information transmitted from software, and verify whether the fingerprint-to-be-verified information conforms to the reference fingerprint information, so as to obtain a processing result. In some embodiments, the processing unit 302 may be specifically configured to compute, with a Popcount algorithm, a total count of bits with different values in corresponding bits of the fingerprint-to-be-verified information and the reference fingerprint information, and take the total count as the processing result. It will be appreciated that the processing result obtained by the processing unit in the present disclosure may be used as an intermediate parameter for subsequently determining whether the fingerprint verification is successful or failed. In other words, the software may, based on the processing result as the intermediate parameter, further determine whether the fingerprint verification is successful or failed later. For example, when the total count of bits with different values in corresponding bits of the fingerprint-to-be-verified information and the reference fingerprint information is greater than a threshold, it is determined that the fingerprint verification is failed.

In some embodiments, the processing unit 302 may be further configured to determine, in response to obtaining the storage parameters transmitted from the software, a storage mode of the processing result according to the storage parameters (for example, determine the storage mode of the processing result according to storage locations, intervals, and the like of various fingerprint information indicated in the storage parameters). The second storage unit 3012 may be configured to interact with the processing unit 302 to obtain the processing result and a storage mode corresponding to the processing result, and output the processing result into the memory address according to the storage mode.

In some implementation scenarios, the storage parameters may include a length value of the fingerprint-to-be-verified information (which, for example, may represent a length value of a fingerprint feature point), an ordering flag that identifies an ordering mode (for example, in close proximity, at intervals, or the like) of processing results in the memory address, and a count flag that identifies a count of reference fingerprint information (which may be specifically prepared by the software in advance based on computation performance of the hardware accelerator). In this application scenario, the programmable parameter unit 3013 may be configured to interact with software to receive the length value of the fingerprint-to-be-verified information, the ordering flag and/or the count flag transmitted from the software. The processing unit 302 may specifically interact with the programmable parameter unit 3013, and may be further configured to compute, in response to obtaining the reference fingerprint information determined from the count flag transmitted from the software, a total count of bits with different values in corresponding bits of the fingerprint-to-be-verified information and each piece of the reference fingerprint information, to acquire a processing result for each piece of the reference fingerprint information.

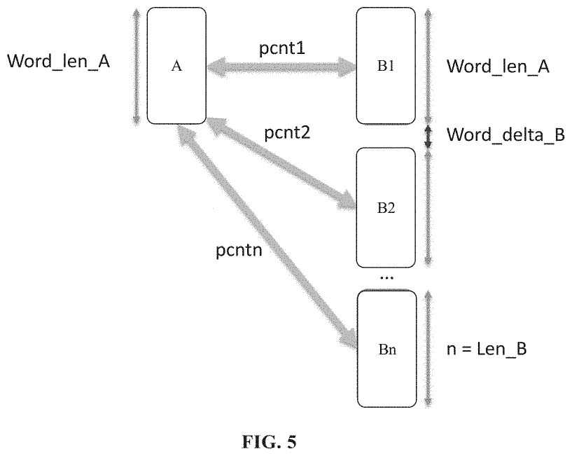

In some embodiments, as shown in FIG. 5, it is provided that the fingerprint-to-be-verified information is A, and the reference fingerprint information comprises B1 to Bn. In the figure. Word_len_A represents the length of A, which may specifically represent a data length of A being 32 bits, 64 bits or more. The data of A may represent the length value of a fingerprint feature point, and the specific physical meaning thereof may be determined by the algorithm. Word_delta_B represents that B1 to Bn are ordered in close proximity (for example, Word_delta_B=0) or at intervals in the memory address. Len_B represents the count of reference fingerprint information, and the software may determine how many of B1 to Bn are computed by the hardware accelerator at one time. Generally, the more of B1 to Bn are computed by the hardware accelerator at one time, the higher the efficiency will be. In this case, the software needs to prepare all of the B1 to Bn according to the computation performance of the hardware accelerator. For each of B1 to Bn, a pcnt value between A and each of B1 to Bn is computed (e.g., pcnt1, pcnt2, . . . , pcntn). Finally, the second processing unit 3012 outputs all processing results (including pcnt1 to pcntn) to the memory address.

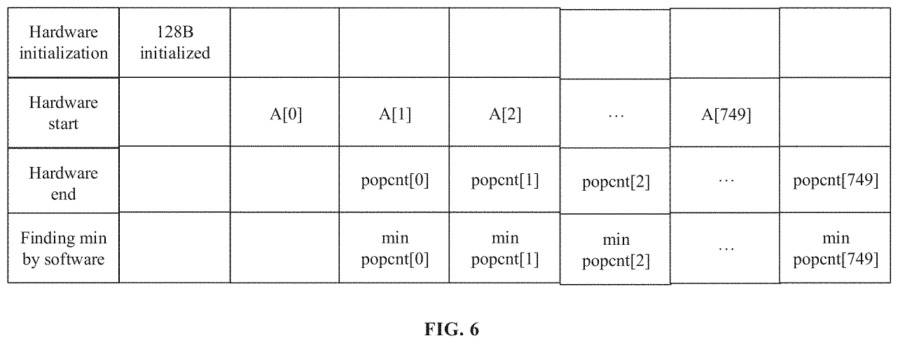

In addition, in some embodiments, the second storage unit 3012 is further configured to store, while acquiring a processing result for a current piece of the reference fingerprint information, a processing result for a previous piece of the reference fingerprint information into the memory address, so that the software simultaneously calls the processing result for the previous piece of the reference fingerprint information. For example, as shown in FIG. 6, in conjunction with the processing performance of the hardware accelerator, the software determines that 128 pieces of reference fingerprint information B can be computed at one time. Each piece of fingerprint-to-be-verified information A[0] to A[749] needs to be computed with 128 pieces of reference fingerprint information B to obtain popcnt[0] to popcnt[749]. After computing a total count of bits with different values in corresponding bits of A[0] and the 128 pieces of reference fingerprint information B, the hardware accelerator (referred to as hardware in FIG. 6 for short) may output popcnt[0]. At this time, the hardware accelerator may continue to compute a total count of bits with different values in corresponding bits of A[1] and the 128 pieces of reference fingerprint information B, while the software may synchronously call popcnt[0] to perform other operations (such as finding min popcnt[0] or the like). Therefore, by scheduling operations of the hardware accelerator and the software, the cooperation between software and hardware is further optimized (for example, the hardware and the software can be seamlessly cooperated with each other, and perform corresponding operations without mutual interference), and the whole fingerprint information processing efficiency is improved.

In some embodiments, the control unit 3014 may be configured to interact with software to receive a trigger instruction for triggering operation of the hardware accelerator transmitted from the software. The processing unit 302 may interacts with the control unit 3014, and may be further configured to perform, in response to receiving the trigger instruction transmitted from the software, relevant operations responsive to the fingerprint verification request. In addition, the control unit 3014 may be configured to feed back an operating state of the hardware accelerator to the software. For example, an operating state of the hardware accelerator may be fed back to the software after the processing result is output, so that the software may conveniently perform overall deployment based on the operating state of the hardware accelerator.

Therefore, with the smart conception of combining software and hardware, the hardware accelerator timely takes over the software to specifically perform verification on the verification data and output the processing result. This fingerprint verification method, which is different from the traditional method that completely depends on software, can effectively improve the fingerprint verification efficiency, and improve the bottleneck of fingerprint verification speed.

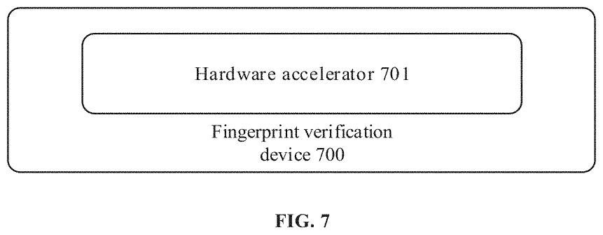

FIG. 7 is a feasible block diagram of a fingerprint verification device 700 according to an embodiment of the present disclosure. As shown in FIG. 7, the fingerprint verification device 700 may comprise a hardware accelerator 701. The hardware accelerator 701 may specifically perform the method in FIG. 1 or 2, or may have the specific structure as shown in FIG. 3 or 4.

In some embodiments, the fingerprint verification device 700 may be provided independent of a portable device such as a mobile phone, a computer, or a smart watch involving fingerprint technology, and may implement fingerprint verification based on interaction between the hardware accelerator 701 and software, so as to feed back a fingerprint verification result to the portable device. Therefore, the technical solution of the present disclosure not only provides a brand-new fingerprint verification method, but also prevents the portable device from accessing some sensitive data during fingerprint verification, thereby improving safety of the fingerprint verification.

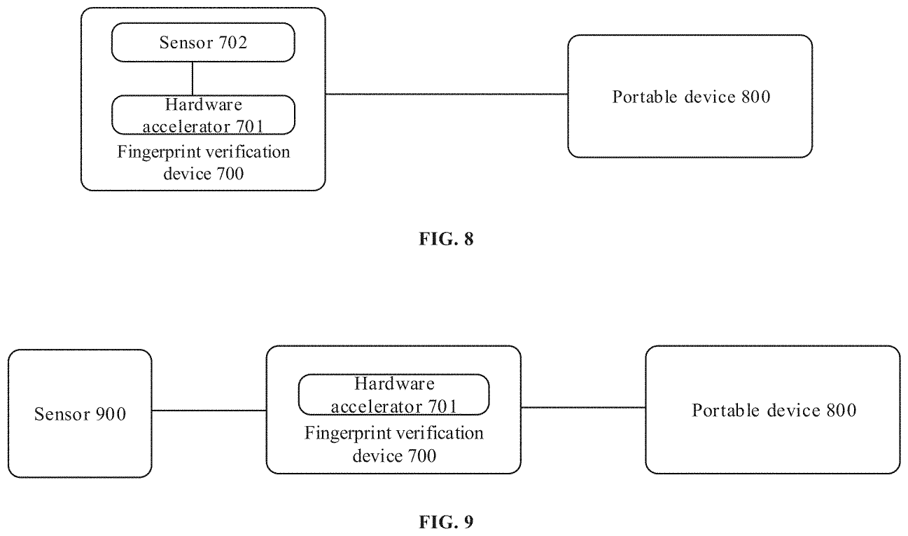

Specifically, as shown in FIG. 8, the fingerprint verification device 700 is provided independent of a portable device 800. In addition to the hardware accelerator 701, the fingerprint verification device 700 may further comprise a sensor 702 configured to capture fingerprint information. During fingerprint verification, the sensor 702 interacts with the hardware accelerator 701 so that the hardware accelerator 701 performs a popcount algorithm to obtain a fingerprint verification result, and then provides the fingerprint verification result to the portable device 800. Thereby, fingerprint verification can be completed inside the fingerprint verification device. It will be appreciated that in this application scenario, the fingerprint verification device 700 may be a fingerprint sensor unit integrated with a hardware accelerator.

In some other embodiments, as shown in FIG. 9, the sensor 900 configured to capture fingerprint information is provided independent of the fingerprint verification apparatus and the portable device 800. In other words, the sensor 900 is provided externally to the fingerprint verification device 700. During fingerprint verification, the sensor 900 (which may be, for example, a fingerprint sensor unit) may provide the captured fingerprint information to the fingerprint verification device 700. The fingerprint verification device 700 executes the popcount algorithm based on the hardware accelerator 701 inside, and provides the resulting fingerprint verification result to the portable device 800. It will be appreciated that in this application scenario, the fingerprint verification device 700 may be a micro controller unit (MCU) integrated with a hardware accelerator.

While various embodiments of the present disclosure have been shown and described herein, it will be obvious to those skilled in the art that such embodiments are provided by way of example only. Numerous modifications, changes, and substitutions will occur to those skilled in the art without departing from the spirit and scope of the present disclosure. It should be understood that various alternatives to the embodiments of the disclosure described herein may be employed in practicing the disclosure. It is intended that the following claims define the scope of the disclosure and that the unit composition, equivalents, or alternatives falling within the scope of these claims are covered thereby.

What is claimed is:

1. A method for processing fingerprint information, the method comprising:
acquiring, in response to detection of a software-initiated fingerprint verification request, verification data from the fingerprint verification request by a hardware accelerator;
performing fingerprint verification on the verification data by the hardware accelerator to obtain a processing result; and
outputting, by the hardware accelerator, the processing result into a memory address specified by the software.

2. The method of claim 1, wherein the verification data includes at least fingerprint-to-be-verified information and reference fingerprint information, and performing fingerprint verification on the verification data by the hardware accelerator to obtain the processing result comprises:
verifying, in response to obtaining the fingerprint-to-be-verified information and the reference fingerprint information transmitted from the software, whether the fingerprint-to-be-verified information conforms to the reference fingerprint information, so as to obtain the processing result.

3. The method of claim 2, wherein verifying whether the fingerprint-to-be-verified information conforms to the reference fingerprint information so as to obtain the processing result comprises:
computing, with a Popcount algorithm, a total count of bits with different values in corresponding bits of the fingerprint-to-be-verified information and the reference fingerprint information, and taking the total count as the processing result.

4. The method of claim 3, wherein the verification data further includes storage parameters, and outputting the processing result into the memory address specified by the software comprises:
determining, in response to obtaining the storage parameters transmitted from the software, a storage mode of the processing result according to the storage parameters; and
outputting the processing result into the memory address according to the storage mode.

5. The method of claim 4, wherein the storage parameters include a length value of the fingerprint-to-be-verified information, an ordering flag that identifies an ordering mode of the processing result in the memory address, and a count flag that identifies a count of reference fingerprint information.

6. The method of claim 5, wherein computing, with the Popcount algorithm, the total count of bits with different values in corresponding bits of the fingerprint-to-be-verified information and the reference fingerprint information comprises:
computing, in response to obtaining the reference fingerprint information determined from the count flag transmitted from the software, a total count of bits with different values in corresponding bits of the fingerprint-to-be-verified information and each piece of the reference fingerprint information, to acquire a processing result for each piece of the reference fingerprint information.

7. The method of claim 6, further comprising:
storing, while acquiring a processing result for a current piece of the reference fingerprint information, a processing result for a previous piece of the reference fingerprint information into the memory address, so that the software simultaneously calls the processing result for the previous piece of the reference fingerprint information.

8. The method of claim 1, wherein the verification data further includes a trigger instruction for triggering operation of the hardware accelerator, and the method further comprises:
performing, in response to acquiring the trigger instruction transmitted from the software, relevant operations responsive to the fingerprint verification request by the hardware accelerator.

9. The method of claim 8, further comprising:
feeding back an operating state of the hardware accelerator to the software by the hardware accelerator.

10. A hardware accelerator comprising:
a software and hardware interaction unit configured to acquire, in response to detection of a software-initiated fingerprint verification request, verification data from the fingerprint verification request; and
a processing unit configured to perform fingerprint verification on the verification data to obtain a processing result, and output the processing result into a memory address specified by the software.

11. The hardware accelerator of claim 10, wherein the verification data includes at least fingerprint-to-be-verified information and reference fingerprint information, and the software and hardware interaction unit comprises a first storage unit configured to obtain the fingerprint-to-be-verified information and the reference fingerprint information transmitted from the software; and
the processing unit is configured to interact with the first storage unit, and is specifically configured to obtain the fingerprint-to-be-verified information and the reference fingerprint information transmitted from the software, and verify whether the fingerprint-to-be-verified information conforms to the reference fingerprint information, so as to obtain the processing result.

12. The hardware accelerator of claim 11, wherein the processing unit is further configured to compute, with a Popcount algorithm, a total count of bits with different values in corresponding bits of the fingerprint-to-be-verified information and the reference fingerprint information, and take the total count as the processing result.

13. The hardware accelerator of claim 12, wherein the verification data further includes storage parameters, the software and hardware interaction unit comprises a second storage unit, and the processing unit is configured to determine, in response to obtaining the storage parameters transmitted from the software, a storage mode of the processing result according to the storage parameters; and
the second storage unit is configured to interact with the processing unit, and output the processing result into the memory address according to the storage mode.

14. The hardware accelerator of claim 13, wherein the storage parameters include a length value of the fingerprint-to-be-verified information, an ordering flag that identifies an ordering mode of the processing result in the memory address, and a count flag that identifies a count of reference fingerprint information.

15. The hardware accelerator of claim 14, wherein the software and hardware interaction unit further comprises a programmable parameter unit configured to interact with the software to receive the length value of the fingerprint-to-be-verified information, the ordering flag and/or the count flag transmitted from the software; and
the processing unit is configured to interact with the programmable parameter unit, and is further configured to compute, in response to obtaining the reference fingerprint information determined from the count flag transmitted from the software, a total count of bits with different values in corresponding bits of the fingerprint-to-be-verified information and each piece of the reference fingerprint information, to acquire a processing result for each piece of the reference fingerprint information.

16. The hardware accelerator of claim 15, wherein the second storage unit is further configured to:
store, while acquiring a processing result for a current piece of the reference fingerprint information, a processing result for a previous piece of the reference fingerprint information into the memory address, so that the software simultaneously calls the processing result for the previous piece of the reference fingerprint information.

17. The hardware accelerator of claim 10, wherein the verification data further includes a trigger instruction for triggering operation of the hardware accelerator, and
the software and hardware interaction unit further comprises a control unit configured to interact with the software to receive the trigger instruction transmitted from the software, and
the processing unit interacts with the control unit, and is further configured to perform, in response to receiving the trigger instruction transmitted from the software, relevant operations responsive to the fingerprint verification request.

18. The hardware accelerator of claim 17, wherein the control unit is further configured to:
feedback an operating state of the hardware accelerator to the software.

19. A fingerprint verification device, comprising at least a hardware accelerator according to claim 10, wherein the fingerprint verification device is provided independent of a portable device, and configured to implement fingerprint verification based on interaction between the hardware accelerator and software, so as to feed back a fingerprint verification result to the portable device.

20. The fingerprint verification device of claim 19, further comprising:
a sensor configured to capture fingerprint information and configured to interact with the hardware accelerator to complete fingerprint verification inside the fingerprint verification device.

21. The fingerprint verification device of claim 19, wherein the fingerprint verification device is further configured to interact with an external sensor configured to capture fingerprint information, so as to interact with the external sensor to implement fingerprint verification.
